(19) United States
(12) Patent Application Publication
(10) Pub. No.: US 2010/0102048 A1
(43) Pub. Date: Apr. 29, 2010

(54) Methods and Apparatus for Welding

(75) Inventors: Sujith Sathian, Simpsonville, SC (US); Gene Arthur Murphy, JR., Pelzer, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/258,177

(22) Filed: Oct. 24, 2008

(51) Int. Cl. B23K 9/00

(52) U.S. Cl. 219/137 PS; 219/136; 219/137 R

(57) ABSTRACT

Embodiments of methods and apparatus for welding are provided. According to one embodiment, an apparatus may include a torch body supporting an electrode at least partially extending from the torch body, the electrode having a longitudinal central axis therethrough. The apparatus may also include a heat transfer block spaced apart from the electrode and at least partially intersecting the longitudinal central axis. An electric arc may be generated between the electrode and the heat transfer block.

### FIELD OF THE INVENTION

The subject matter disclosed herein relates to welding, and more specifically relates to methods and apparatus for welding.

### BACKGROUND OF THE INVENTION

Various techniques exist for welding metals, such as for fabrication or repair. One conventional technique known as gas tungsten arc welding (“GTAW”) generates an electric arc between a welding torch electrode and a work piece to which the weld is applied. GTAW systems typically use a non-consumable, tungsten electrode. Additionally, a shielding gas, typically an inert, non-reactive gas, such as argon, is delivered along the path of the electrode. The electric arc is produced as a result of current being delivered from a power source to the electrode and through the conductive, ionized shielding gas. The heat energy of created by the electric arc formed at the work piece at least partially melts the work piece and any filler metals applied to the electric arc at or near the work piece, creating a weld puddle which ultimately results in the desired weldment.

However, conventional GTAW techniques may not be suitable for welding relatively thin metals because the high heat energy created by the electric art may distort or otherwise compromise the integrity of the relatively thin metals. Additionally, when performing repair on already machined or fabricated components, GTAW techniques may create an undesirable greater hardness in heat affected zones. Typically, to rectify high hardness, post weld heat treatment is performed to reduce the hardness and increase ductility. However, post weld heat treatments are not always appropriate for relatively thin and/or already machined metals because distortion may result.

Accordingly, there exists a need for improved methods and apparatus for welding. There exists a further need to reduce the heat to which relatively thin metal work pieces are exposed during welding.

### BRIEF DESCRIPTION OF THE INVENTION

According to one embodiment of the invention, there is disclosed an apparatus for welding a work piece. The apparatus may include a torch body supporting an electrode at least partially extending from the torch body, the electrode having a longitudinal central axis therethrough. The apparatus may also include a heat transfer block spaced apart from the electrode and at least partially intersecting the longitudinal central axis. An electric arc may be generated between the electrode and the heat transfer block.

According to another embodiment of the invention, there is disclosed a method of welding a work piece. The method may include providing a torch body supporting an electrode at least partially extending from the torch body, the electrode having a longitudinal central axis therethrough, providing a heat transfer block spaced apart from the electrode and at least partially intersecting the longitudinal central axis, and positioning the torch body and the heat transfer block in a plane spaced at least partially above the metal work piece. The method may also include supplying current to the electrode to form an electric arc between the electrode and the heat transfer block, and delivering a filler proximate to the electric arc, wherein the filler is substantially liquefied and deposited on the metal work piece positioned at least partially below the electric arc.

According to yet another embodiment of the invention, there is disclosed a method for welding a work piece using an arc weld device. The method may include generating an electric arc between an electrode of a weld device and a heat transfer block spaced apart from the electrode, and delivering a filler proximate to the electric arc, wherein the filler is substantially liquified and deposited on the metal work piece positioned substantially below the electric arc.

Other embodiments, aspects, and features of the invention will become apparent to those skilled in the art from the following detailed description, the accompanying drawings, and the appended claims.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a partial side view of an example welding system and associated apparatus, in accordance with one embodiment of the invention;

FIG. 2 is a partial side view of an example welding system and associated apparatus, in accordance with one embodiment of the invention;

FIG. 3 is a partial side view of an example welding system and associated apparatus, in accordance with one embodiment of the invention;

FIG. 4 is a partial side view of an example welding system and associated apparatus, in accordance with one embodiment of the invention;

FIG. 5 is a partial side view of an example welding system and associated apparatus, in accordance with one embodiment of the invention;

FIG. 6 is a partial side view of an example welding system and associated apparatus, in accordance with one embodiment of the invention;

FIG. 7 is a partial top view of an example welding system and associated apparatus, in accordance with one embodiment of the invention;

FIG. 8 is a partial side view of an example welding system and associated apparatus, in accordance with one embodiment of the invention;

FIG. 9 is a partial side view of an example welding system and associated apparatus, in accordance with one embodiment of the invention;

FIG. 10 is a flow chart illustrating an example method for welding a metal work piece, in accordance with one embodiment of the invention.

### DETAILED DESCRIPTION OF THE INVENTION

Illustrative embodiments of the invention now will be described more fully hereinafter with reference to the accompanying drawings, in which some, but not all embodiments are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are methods, systems, and apparatus for welding a work piece. According to an embodiment of the invention, a welding apparatus or torch, similar to those used for conventional GTAW welding, may be adaptable to deliver an electric arc between an electrode and a heat transfer block rather than from the electrode directly to the work piece, to reduce the heat generated on or at the work piece. For example, a welding apparatus or torch may include a torch body supporting an electrode, such as a nonconsumable electrode, at least partially extending from the torch body. The electrode defines a longitudinal central axis extending therethrough. The apparatus may further include a heat transfer block spaced apart from the electrode and at least partially intersecting the longitudinal central axis. For example, the heat transfer block may be placed at a distance in front of, and not touching, the electrode. When a current is delivered to the electrode, an electric arc is generated between the electrode and the heat transfer block, both of which would be placed above a work piece, in an approximately parallel plane above the work piece. The heat transfer block serves as a conductor for receiving the electric arc, but also for receiving heat energy created by the electric arc, and to dissipate the heat energy externally rather than transfer the heat energy to the work piece. Accordingly, by concentrating heat energy on a heat transfer block instead of a work piece, the risks of distortion, excessive hardening, and/or embrittlement may be reduced or avoided.

The heat transfer block may be any electrically conductive material having good heat transfer and thermal conductivity characteristics. In one example, the heat transfer block is at least partially comprised of copper. Though, other example heat transfer blocks may comprise, but are not limited to, silver, gold, aluminum, or any alloy thereof, for example. According to one aspect, the heat transfer block may further include a cooling element, such as water or another coolant flowing through one or more coolant paths formed within the heat transfer block.

According to one embodiment, an example welding apparatus may further include one or more gas nozzles operable to deliver gas along various paths. The gas may be a shielding gas, such as any inert or semi-inert, non-reactive gas as is conventionally used when performing gas arc welding. For example, one gas nozzle may deliver gas substantially from the torch body toward the heat transfer block, approximately along the path of electric arc (e.g., along the longitudinal central axis). In another example, one or more gas nozzles may be deliver gas along a path or paths that at least partially intersect the path of the electric arc and toward the work piece (e.g., intersecting the longitudinal central axis). For example, a gas nozzle may be operable to direct gas toward the work piece along the path of a filler delivered to the electric arc. Accordingly, the one or more gas nozzles may serve to shield the electrode and the arc to avoid unpredictable arcing characteristics, and/or to avoid the filler metal or the weld puddle from oxidizing.

In use, a filler material may be delivered proximate to the electric arc, such that when near the electric arc, the filler is substantially liquified into a molten metal and deposits onto the work piece positioned substantially below the electric are. Gravity causes the liquiefied filler to drop onto the work piece. The heat of the liquified filler may further melt the work piece, creating a conventional weld puddle.

As used herein, the terms “at least partially intersecting,” “substantially intersecting,” and “intersecting” may be used interchangeably to generally refer to two paths that may intersect at one point. For example, when delivering a shielding gas from above a work piece, the shielding gas may be considered to “at least partially intersect” an electric arc or an axis if at least part of the shielding gas passes through or over the path of the arc or the axis. In another example, a heat transfer block may be considered to “at least partially intersect” an axis extending from the center of an electrode if the axis would touch or extend through the heat transfer block when extended to or past the position of the block. Accordingly, the terms “at least partially intersecting,” “substantially intersecting,” and “intersecting” are intended to be used generally, describing a general direction of one path relative to another, and are not intended to overly limit the extent or magnitude by which paths must intersect or otherwise cross.

Similarly, as used herein, the terms “approximately along,” “substantially along,” “at least partially along,” and “along” may be used interchangeably to generally refer to one path lying in the same general direction as another, irrespective of their varying degrees of specific orientation. For example, a gas path may be considered to be delivered “substantially along” an axis if it extends from at or near the same origin and is delivered at or near the same termination point such as a gas path extending from the torch body near an electrode and terminating at a heat transfer block along a similar path as the electric arc. Accordingly, the terms “approximately along,” “substantially along,” “at least partially along,” and “along” are intended to be used generally, describing a general direction of one path relative to another, and are not intended to overly limit the direction or orientation of respective paths.

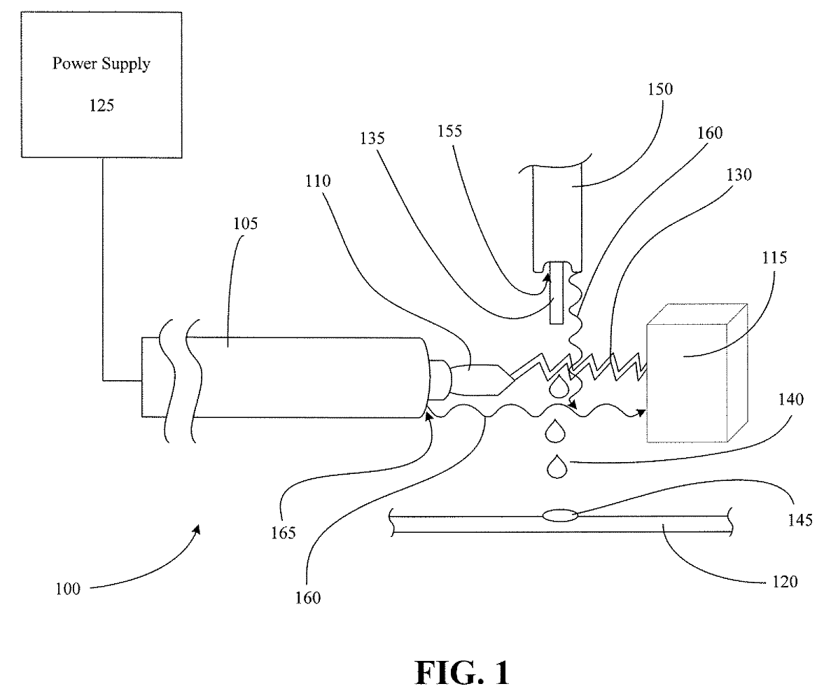

FIG. 1 is a representation of a portion of an example welding system 100 and associated apparatus, according to one embodiment of the invention. The welding system may include a torch body 105, which supports at least one electrode 110. The torch body 105 may be any torch body or device as is typically used to perform gas arc welding. In one example, the electrode 110 may be a nonconsumable electrode such as tungsten; though, other nonconsumable electrodes may be used. At a position spaced apart from the tip of the electrode 110, a heat transfer block 115 is included. The heat transfer block 115 may be positioned to at least partially intersect the longitudinal central axis defined by the electrode 110 (as is more fully illustrated in other figures herein). Both the torch body 105 and the heat transfer block 115 may be positioned in a plane above or at least partially above a metal work piece 120 to be welded. In the example illustrated in FIG. 1, the torch body 105 and the heat transfer block 115 are positioned to lie substantially horizontally and substantially parallel to the metal work piece 120. However, in other example embodiments, the torch body 105 may be positioned at any angle allowing for an electric arc to be created between the electrode 110 and the heat transfer block 115 and a filler material to be delivered near the electric arc and deposited (by gravity) to the work piece 120 below, such as a forty five degree angle from the work piece 120, or a sixty degree angle from the work piece 120, or at any angle allowing filler to be delivered to the electric arc and deposited on the work piece lying below.

The welding system 100 may further include at least one power supply 125 in electrical communication with the electrode 110 for delivering a current to the electrode to create an electric arc 130 between the electrode 110 tip and the heat transfer block 115. The power supply 125 may be any suitable power supply for delivering current to a nonconsumable electrode. For example, the power supply 125 may supply a constant current or a constant voltage. For example, if the welding system 100 is used as an automatic welding system, a constant voltage power supply may be used to allowing varying the current. In another example, if the welding system 100 is used as a manual welding system, the power supply may be a constant current power supply, allowing the voltage to vary, such as may be done when the electric arc 130 length varies relative to the heat transfer block. Moreover, the power supply 125 may be a direct current power supply or an alternating current power supply.

A filler 135 may be provided and delivered at or near the electric arc 130 for liquifying and depositing on the work piece 120. The filler 135 may be composed of any metal having a matching or compatible chemistry to that of the work piece 120. For example, the filler 135 may be, but is not limited to, carbon steel, nickel, cobalt, iron, stainless steel, any alloy thereof, and the like. When delivered to the electric arc 130, the filler 135 may at least partially liquify into molten metal 140 and deposit onto the work piece 120 by gravity. When deposited on the work piece, the molten metal 140 may heat and at least partially liquify the work piece 120, creating a weld puddle 145 comprising the molten metal and liquified work piece.

In one embodiment, the filler 135 may be delivered automatically, such as through a filler delivery port 150 connected to an automatic feeder. In another embodiment, however, the filler 135 may be delivered manually, either through a filler delivery port 150 connected to a manual advance or manually delivered by hand.

In one embodiment, one or more gas nozzles may be included with the welding system 100. The gas nozzles may deliver shielding gas, such as an inert or semi-inert, non-reactive gas to shield the electrode 110, the electric arc 130, the filler 135, the molten metal 140, and/or the weld puddle 145 from the elements and to prevent oxidation as may otherwise occur if exposed directly to oxygen. The shielding gas may be, but is not limited to, argon, helium, radon, any combination thereof and the like. In one example embodiment, a first gas nozzle 155 may be combined with the filler delivery port 150 such that shielding gas 160 may be delivered in substantially the same path as the filler 135 and the molten metal 140 toward the work piece 120. In another embodiment, a second gas nozzle 165 may be integrated within the torch body 105 such that shielding gas 160 may be delivered along the path of the electric arc 130 from the torch body 105 toward the heat transfer block 115. Each of the gas nozzles 155, 165 may be connected to an external gas supply. As described further herein, shielding gas 160 may be delivered from various angles and across many points of the welding system 100. For example, multiple gas nozzles may be positioned to radially with respect to the longitudinal central axis of the electrode 110 to deliver shielding gas 160 from multiple positions above the electric arc 130 and toward the work piece 120. Yet, in another embodiment, the welding system 100 may not include any gas nozzles and may not deliver shielding gas, such as an embodiment in which the welding system 100 is operated in a vacuum, eliminating exposure to oxygen. An embodiment operated in a vacuum may be used when welding titanium, for example.

The heat transfer block 115 illustrated in FIG. 1 may be composed of any electrically conductive material having good heat transfer characteristics. For example, copper, silver, gold, aluminum, or any alloy thereof, may be used to form a heat transfer block 115. The purpose of the heat transfer block 115 is to receive the electrical current and form the electric arc 130 with the electrode 110. Doing so causes much of the heat energy generated to be absorbed by the heat transfer block 115, instead of by the work piece 120, as would occur in conventional GTAW welding systems. In one embodiment, the heat transfer block 115 may also include a cooling element. In one example, the cooling element may include circulating water or another coolant through one or more coolant paths formed within or adjacent to the heat transfer block. For example, coolant paths may be formed within the heat transfer block 115 to deliver a coolant through the heat transfer block 115, such that the coolant absorbs heat energy and delivers it to an external heat sink, such as a volume of water or other fluid.

The heat transfer block 115 may rest directly on the work piece 120, or may be suspended or otherwise separated from the work piece 120. In one embodiment, the heat transfer block 115 may be affixed to the torch body 105, such that it moves with the torch when performing a weld. In other embodiments, however, the torch body 105 may move independent of the heat transfer block 115. For example, the heat transfer block 115 may be dimensioned to be at least the length of the intended weld, such that it is aligned with the welding area of the work piece 120 and remains stationary while the torch body 105, and thus the electric arc 130, is moved along the welding area and the heat transfer block 115. In another embodiment, the heat transfer block 115 may be dimensioned to be less than the length of the intended weld, and may be moved with the torch body 105, whether or not it is affixed to the torch body 105.

The welding system 100 as illustrated in FIG. 1 (or in other figures herein) may be used as an automatic welding system, whereby the torch body is automatically moved along the work piece, and gas and filler are automatically delivered, forming the desired weldment. In other embodiments, however, the welding system 100 may be a manual welding system, or a semi-automatic welding system, at least partially operated by hand.

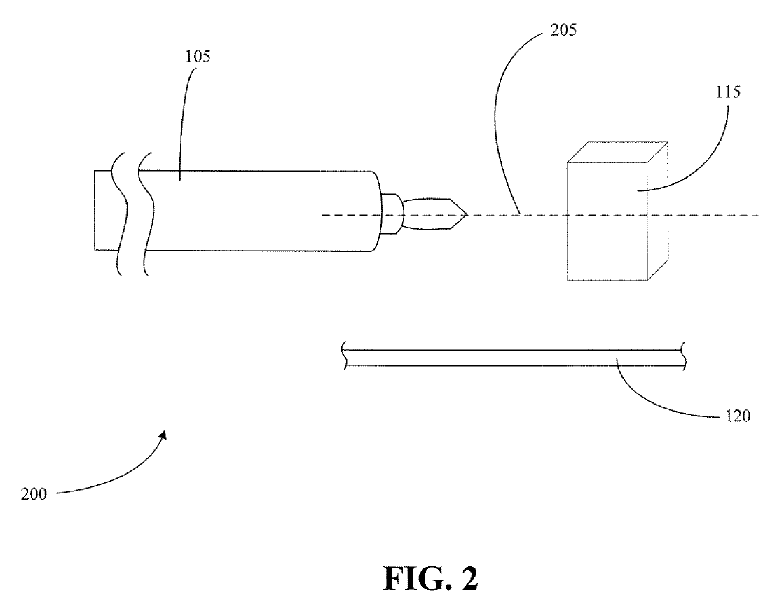

FIG. 2 is a representation of a portion of an example welding system 200 and associated apparatus, according to one embodiment of the invention. The electrode 110 defines a longitudinal central axis 205 extending therethrough, as illustrated in FIG. 2. The longitudinal central axis 205 may be used to help determine the positioning of the heat transfer block 115 and other system components, such as one or more gas nozzles and a filler delivery port. The heat transfer block 115 may be positioned to at least partially intersect the longitudinal central axis 205. The electric arc 130 will thus be formed approximately along the longitudinal central axis 205 between the electrode 110 tip and the heat transfer block, as is illustrated in FIG. 1. Although FIG. 2 illustrates the longitudinal central axis 205 approximately horizontal and parallel to the work piece 120, in other embodiments it may be positioned at any angle that allows filler to be delivered to the electrical arc and deposited by gravity onto the work piece below without being obstructed by the heat transfer block 115.

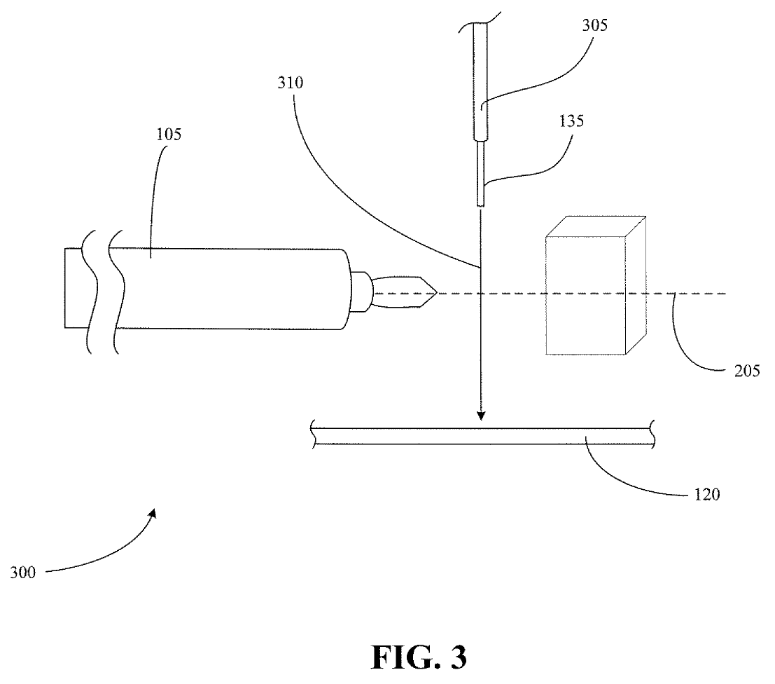

FIG. 3 is a representation of a portion of an example welding system 300 and associated apparatus, according to one embodiment of the invention. In this example embodiment, the welding system 300 includes a filler delivery port 305 that is not integrated with a gas nozzle. The filler delivery port 305 may be a manual or an automatic delivery port for delivering filler 135. FIG. 3 also illustrates the filler path 310 as at least partially intersecting the longitudinal central axis 205 described with reference to FIG. 2, which causes the filler 135 to be delivered proximate to the electric arc. While FIG. 3 illustrates the filler path 310 as perpendicular to the longitudinal central axis 205, in other embodiments, the filler delivery port 305 may position the filler path 305 at any position such that the filler 135 may be deposited by gravity onto the work piece 120.

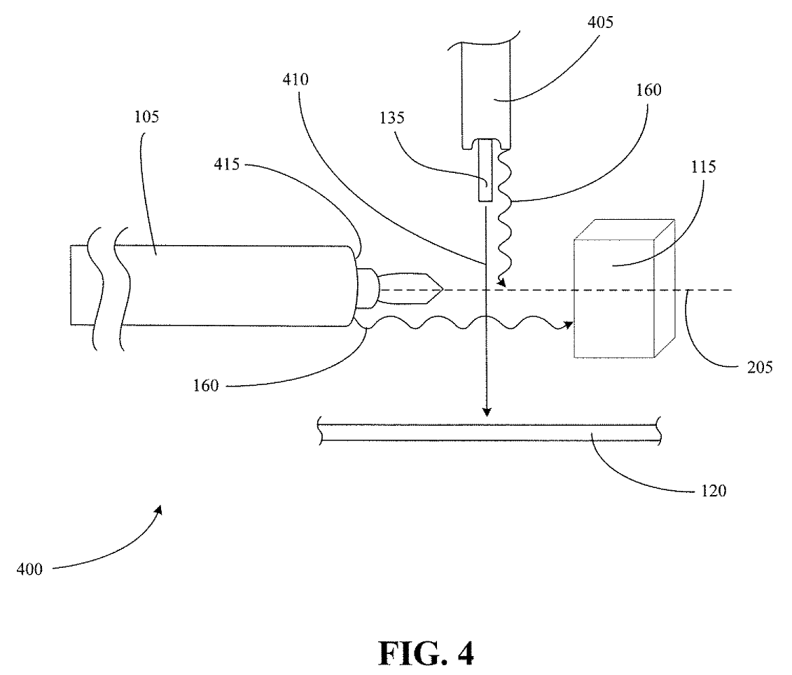

FIG. 4 is a representation of a portion of an example welding system 400 and associated apparatus, according to one embodiment of the invention, illustrating example gas and filler paths with respect to the orientation of the torch body, the electric arc, the heat transfer block, and the work piece. In this example embodiment, the welding system 400 includes a combination gas nozzle and filler delivery port 405 operable to deliver filler 135 and shielding gas 160. Using a combination gas and filler delivery port 405 allows delivering shielding gas 160 substantially along the same path as the filler path 410 toward the work piece 120, substantially intersecting the longitudinal central axis 205 of the electrode. Accordingly, the shielding gas 160 delivered along this path may shield the filler 135, resulting molten metal, and the weld puddle from oxidation. The combination gas nozzle and filler delivery port 405 may either manually or automatically deliver filler 135, as described herein.

The torch body 105 may also include a gas nozzle 415 operable to deliver shielding gas 160 along substantially the same path of the electric arc from the torch body 105 toward the heat transfer block 115 along the longitudinal central axis 205. Shielding gas 160 delivered along this path may shield the electrode and the electric arc from the elements, preventing oxidation and providing a more predictable and reliable arc. In other embodiments, however, the welding system 400 may include only one of the gas nozzles 405, 415, may include additional gas nozzles, or may not include any gas nozzles, such as when welding in a vacuum environment so oxidation is not a concern.

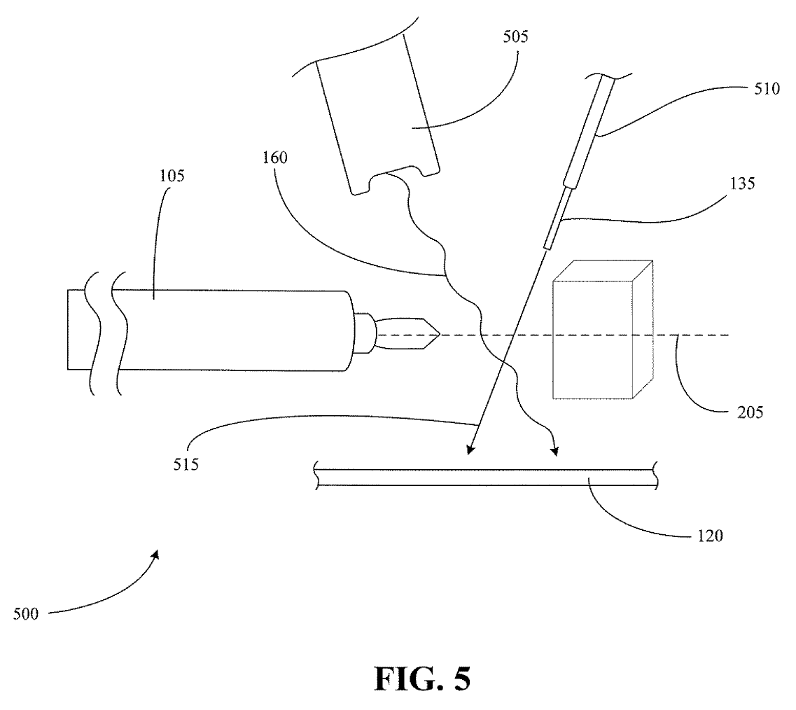

FIG. 5 is a representation of a portion of an example welding system 500 and associated apparatus, according to one embodiment of the invention, illustrating additional example gas paths and filler paths with respect to the orientation of the torch body, the electric arc, the heat transfer block, and the work piece. In this example embodiment the welding system 500 includes at least one gas nozzle 505 operable to deliver a shielding gas 160 and a separate filler delivery port 510 operable to deliver filler 135. The filler delivery port 510 may either manually or automatically delivery filler 135, as described herein. The one or more gas nozzles 505 and the filler delivery port 510 may be spaced radially around the longitudinal central axis 205, directing shielding gas 160 and a filler path 515, respectively, in paths substantially intersecting the longitudinal central axis 205 toward the work piece 120, thus crossing the electric arc when generated. In other embodiments, the gas nozzle 505 and/or the filler delivery port 510 may not be spaced radially apart, but positioned to deliver gas 160 and/or a filler path 515, respectively, at different angles relative to the longitudinal central axis 205. Also, in certain embodiments, the torch body may optionally include one or more gas nozzles operable to deliver gas along substantially the same path of the electric arc from the torch body 105 toward the heat transfer block along the longitudinal central axis 205.

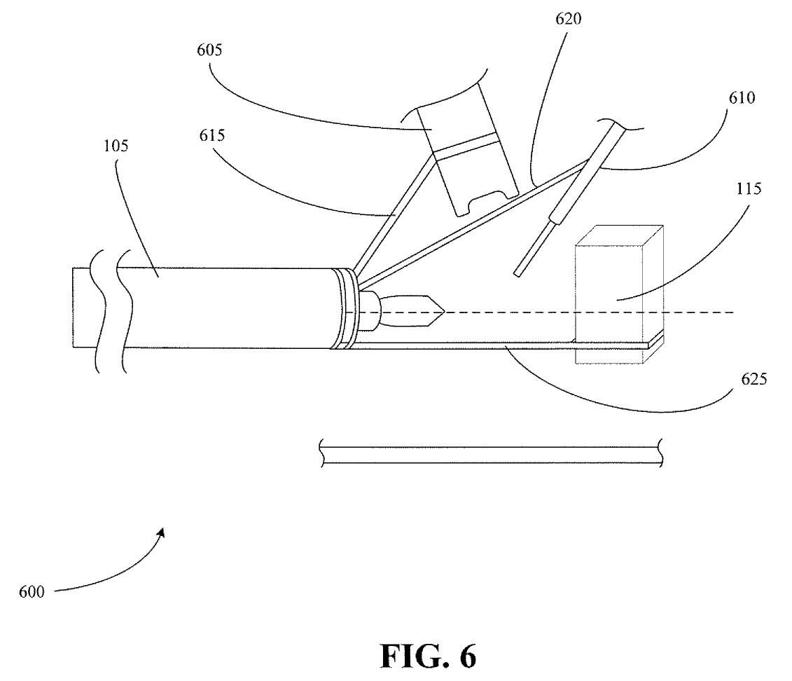

FIG. 6 is a representation of a portion of an example welding system 600 and associated apparatus, according to one embodiment of the invention, illustrating example gas nozzles, a filler delivery port, and a heat transfer block supported by the torch body. The welding system 600 shown includes at least one gas nozzle 605, a separate filter delivery port 610, and a heat transfer block 115. The gas nozzle 605 is supported by at least one gas nozzle mounting member 615 attached to at least one point on the torch body 105 and to at least one point on the gas nozzle 605. The gas nozzle mounting member 615 may be removeably affixed to the torch body 105 and/or the gas nozzle 605, such as by sliding an attachment ring over the torch body 105 or the gas nozzle 605, by using releasable pins, and the like. In another embodiment, the gas nozzle mounting member 615 may be permanently affixed to the torch body 105 and/or the gas nozzle 605, such as by screws, rivets, adhesive, welding, and the like. The gas nozzle mounting member 615 may be adjustable in both length and position, to allow adjusting the desired placement of the gas nozzle 605.

The filler delivery port 610 and the heat transfer block 115 may also be removeably or permanently affixed to the torch body 105 by at least one filler delivery mounting member 620 and at least one block mounting member 625, respectively, in a same or similar manner as the gas nozzle mounting member 615. The one or more filler delivery mounting members 620 and block mounting members 625 may also be adjustable in both length and position, to allow adjusting the position of the filler delivery port 610 and the heat transfer block 115 as desired. In certain embodiments, mounting members may used with any of the embodiments illustrated or described herein to support any or all of the system components by mounting members in a same or similar manner as described with reference to FIG. 6.

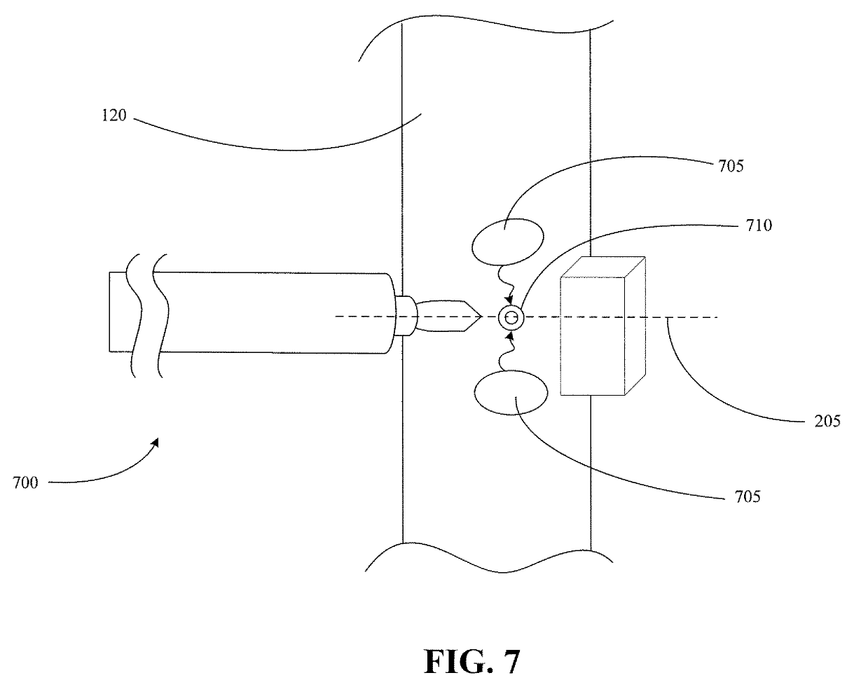

FIG. 7 is a top view representation of a portion of an example welding system 700 and associated apparatus, according to one embodiment of the invention, illustrating example gas nozzle and filler delivery port placement with respect to the orientation of the torch body and the heat transfer block. In this example embodiment, the welding system 700 includes multiple gas nozzles 705 radially spaced apart around the longitudinal central axis 205 defined by the electrode. The gas delivery nozzles 705 are operable to deliver shielding gas 160 in a direction toward a work piece 120 and at least partially intersecting the longitudinal central axis 205. Also included is a filler delivery port 710 operable to deliver a filler in a direction toward the work piece 120 and at least partially intersecting the longitudinal central axis 205. The filler delivery port 710 is illustrated as being positioned directly above the longitudinal central axis 205; although, in other embodiments it may be offset, such as at another position extending radially from the longitudinal central axis 205 or any other position able to deliver filler toward the work piece 120 and proximate to the electric arc.

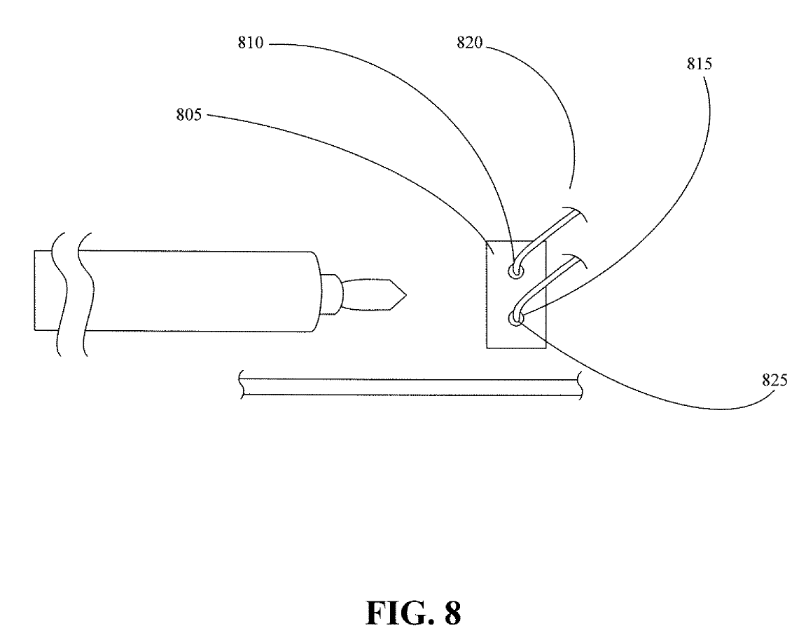

FIG. 8 is a representation of a portion of an example welding system 800 and associated apparatus, according to one embodiment of the invention, illustrating an example heat transfer block adaptable to include a cooling element, such as by delivering a coolant through the block to aid in heat transfer qualities. According to one example embodiment, the heat transfer block 805 illustrated in FIG. 8 may include a cooling element which includes a coolant inlet 810 and a coolant outlet 815 in fluid communication with a coolant delivery tube 820 and coolant return tube 825, respectively. Accordingly, the coolant delivery tube 820 may deliver coolant from an external source, such as a volume of water or other fluid, to coolant paths formed through the heat transfer block 805 and return the coolant through the coolant return tube 825 to an external heat sink, such as a volume of water or other fluid. In one example, the external coolant source and the external heat sink may be the same volume of fluid, allowing for re-circulation and conservation of the coolant; though in other embodiments they may be separate volumes to provide optimum cooling of the heat transfer block 805. The coolant may be mechanically pumped, gravity fed, siphoned, or delivered to the heat transfer block 805 using any other suitable techniques. In certain embodiments, other cooling elements and/or cooling techniques may be applied to the heat transfer block instead of or in addition to, delivering a coolant, such as heat sink fins, fans, refrigerant, and the like.

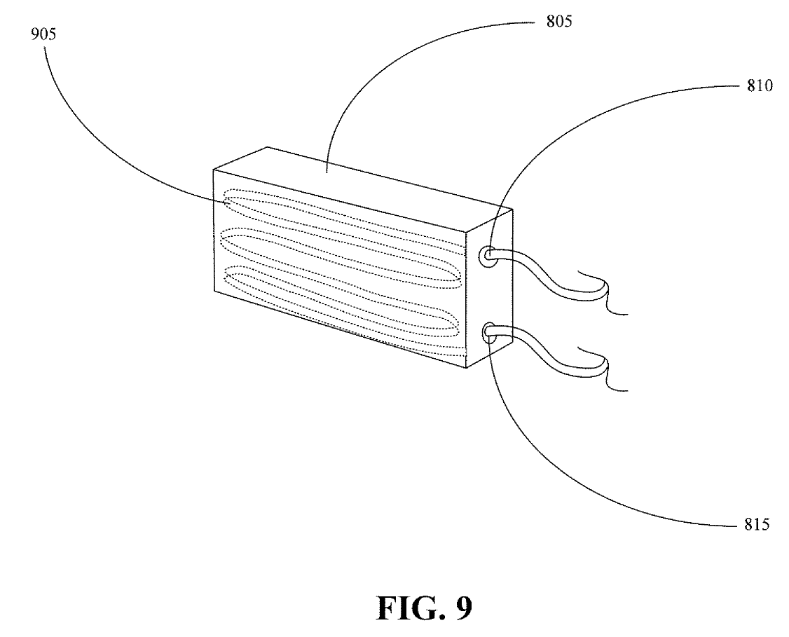

FIG. 9 is a representation of an example heat transfer block 805 having cooling element including a coolant path formed therein as a cooling element, as described in reference to FIG. 8. As shown, a coolant path 905 may be formed within the heat transfer block 805 to provide a path to for delivering a coolant therethrough. In one example, the coolant path 905 may be formed in a serpentine shape beginning at the coolant inlet 810 and ending at the coolant outlet 815 to increase the exposure of the coolant to the surface area of the heat transfer block 805, improving the heat transfer from the block to the coolant. Though, in other embodiments, the coolant path 905 may be formed in other patterns. Moreover, although only a single coolant path 905, coolant inlet 810, and coolant outlet 815 are illustrated in FIG. 9, in other embodiments, additional coolant paths may be formed between additional coolant inlets and outlets. For example, to simplify forming the heat transfer block 805, one or more coolant paths may be formed in a substantially direct path from a cooling inlet on one side of the heat transfer block 805 to a coolant outlet on the other side.

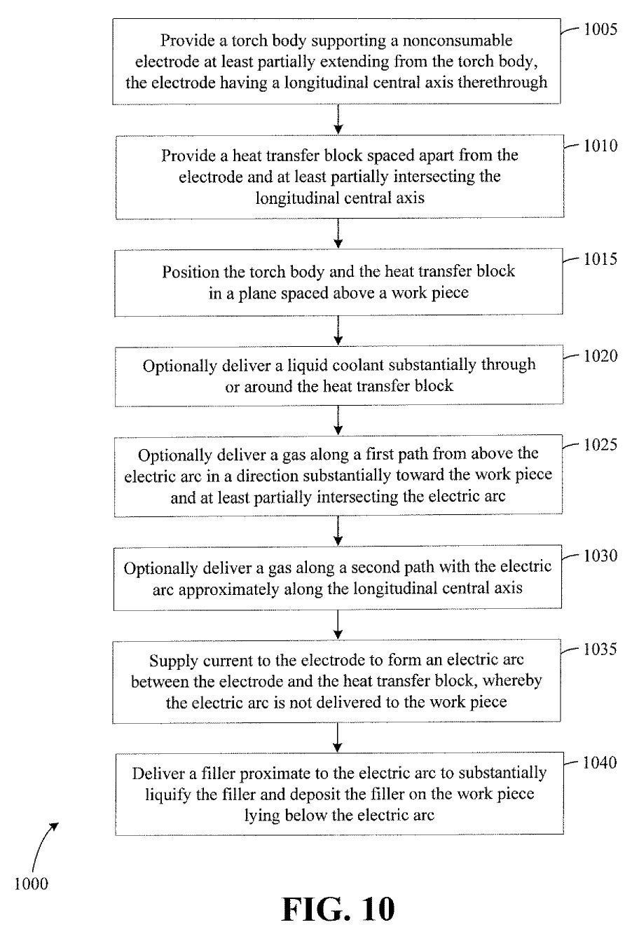

FIG. 10 is a flowchart illustrating one example method for performing a weld using a welding system in accordance with an illustrative embodiment of the invention.

The method 1000 begins at block 1005. At block 1005 a torch body is provided that supports a nonconsumable electrode at least partially extending from the torch body. The torch body and electrode configuration may be any system as described or illustrated herein, for example the torch body 105 and electrode described with reference to FIG. 1. The electrode defines a longitudinal central axis extending therethrough, which may be used to assist positioning and placement of other welding system components.

Following block 1005 is block 1010, in which a heat transfer block is positioned spaced apart from the electrode and at least partially intersecting the longitudinal central axis defined by the electrode. For example, the heat transfer block may be placed at a distance in front of, and not touching, the electrode. In one embodiment, the heat transfer block may be removeably or permanently supported by the torch body, for example as is described with reference to FIG. 6. In other embodiments, however, the heat transfer block may be separate from the torch body and the torch body may move independent of the heat transfer block. According to one embodiment, the heat transfer block may include a cooling element, such as a cooling path and be adaptable to have a coolant, such as water or another fluid, delivered therethrough, such as is described with reference to FIGS. 8 and 9.

Following block 1010 is block 1015, in which the torch body and the heat transfer block are positioned in a plane spaced above a metal work piece to be welded. According to one embodiment, the heat transfer block may rest on the metal work piece. In other embodiments, however, the heat transfer block may be spaced apart from the metal work piece, for example by additional spacers or when supported by the torch body. Positioning the torch body and the heat transfer block above the work piece allows filler to be deposited at least in part by gravity to the work piece. Thus, the torch body and the heat transfer block may be positioned at any angle with respect to the work piece that allows filler to be delivered proximate to an electric arc created therebetween and deposited on a work piece lying at least partially below.

Following block 1015 is block 1020, in which coolant may be optionally delivered to the heat transfer block. Coolant, such as water or another fluid, may be delivered to further extract heat energy from the heat transfer block and away from the metal work piece. Directing heat energy away from the work piece reduces excessive heating of the work piece and may prevent distortion, embrittlement, or other negative consequences of over heating a thin metal work piece. Coolant may be delivered an any manner as is described or illustrated herein, for example with reference to FIG. 8 or 9. In other embodiments, at block 1020 the heat transfer block may be cooled using elements including techniques other than delivering coolant, such as using heat sink fins, fans, refrigerant, and the like.

Following block 1020 is block 1025, in which a gas, such as a shielding gas described herein, is optionally delivered along a first gas path from above the longitudinal central axis toward the work piece positioned below the torch body. The gas path may be delivered so as to at least partially intersect the longitudinal central axis, thus intersecting the electric arc when delivered. This gas path may serve to shield the filler, molten metal, and/or the weld puddle from exposure to contaminants and to prevent oxidation. A gas nozzle for delivering the shielding gas may be positioned in any manner to deliver the gas toward the work piece and to at least partially intersect the longitudinal central axis, such as is described herein with reference to FIGS. 1-7, for example.

Following block 1025 is block 1030, in which a gas, such as a shielding gas described herein, is optionally delivered along a second gas path from the torch body and toward the heat transfer block approximately along the longitudinal central axis, for example as is described with reference to FIG. 1 or 4. The second gas path may serve to shield the electrode and the electric arc from the elements, preventing oxidation and providing a more predictable and reliable arc.

Additional gas paths may optionally be provided with various embodiments of the invention, such as is described or illustrated herein.

Following block 1030 is block 1035, in which electric current is delivered from a power supply to the electrode. Upon delivering current to the electrode, an electric arc may be formed between the electrode tip and the heat transfer block. The electric arc provides the heat energy for melting filler to be deposited on the work piece. The intensity of the electric arc may be adjustable using an adjustable power supply, such as a variable current or variable voltage power supply.

Following block 1035 is block 1040, in which a filler metal is delivered proximate to the electric arc to at least partially liquify the filler metal into molten metal for depositing onto the work piece lying at least partially below the electric arc. As described herein, the filler may be delivered automatically or manually. Because filler is delivered to an electric arc above the work piece, upon liquification, the molten metal may drop to the work piece due to gravity. Upon contacting the work piece, the molten metal may be at a temperature greater than the melting point of metal work piece, causing the work piece to at least partially liquify and create a weld puddle constituting the molten filler metal and the melted work piece metal.

In addition, when delivering the filler, one or more of the gas nozzles may be used to assist directing the molten metal to the desired welding position on the work piece. For example, the gas nozzle may deliver shielding gas at a high enough force and pressure such that the path of the shielding gas may also impact the path of the molten metal after liquification by the electric arc. Accordingly, altering the position of one or more gas nozzles may aid in controlling the deposition of the molten metal on the work piece.

Moving the torch and the filler along the area of the work piece to be welded will result in a weld similar to those created using conventional GTAW welding, but without excessively heating the metal work piece.

The method 1000 may end after block 1040.

Accordingly, embodiments of the invention include a welding system adaptable to deliver an electric arc between an electrode and a heat transfer block, rather than from the electrode directly to the work piece as is done during conventional GTAW welding Redirecting the heat energy from the work piece to the heat transfer block allows using arc welding techniques on thin metals, such as those at or below approximately 2 millimeters, without overheating the metals, which may otherwise result in excessive hardening, deformation, and embrittlement. Thus, when fabricating devices using thin metals, and/or when repairing thin metals or already machined metals, embodiments described or illustrated herein may be employed to avoid the undesirable consequences of traditional GTAW welding techniques.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims

This written description uses examples to disclose embodiments of the invention, including the best mode, and also to enable any person skilled in the art to practice the invention, including making and using any devices or systems and performing any incorporated methods. The patentable scope of embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The claimed invention is:

1. An apparatus for welding a work piece, comprising:
a torch body supporting an electrode at least partially extending from the torch body, the electrode having a longitudinal central axis therethrough; and
a heat transfer block spaced apart from the electrode and at least partially intersecting the longitudinal central axis;
wherein an electric arc is generated between the electrode and the heat transfer block.

2. The apparatus of claim 1, further comprising at least one gas nozzle positionable to deliver at least one gas along a path that at least partially intersects the electric arc.

3. The apparatus of claim 1, further comprising:
a first gas nozzle operable to deliver at least one gas along a first path that at least partially intersects the electric arc;
a second gas nozzle operable to deliver at least one gas along a second path in between the torch body and the heat transfer block;
wherein the first path at least partially intersects the longitudinal central axis and wherein the second path lies substantially along the longitudinal central axis.

4. The apparatus of claim 1, wherein the heat transfer block comprises at least one cooling element.

5. The apparatus of claim 4, further comprising a liquid coolant for circulation in the at least one cooling element.

6. The apparatus of claim 1, wherein the heat transfer block is supported by the torch body.

7. The apparatus of claim 1, wherein the heat transfer block comprises copper.

8. The apparatus of claim 1, further comprising a filler delivery port operable to deliver at least one filler along a first path directed toward the electric arc and at least partially intersecting the longitudinal central axis.

9. The apparatus of claim 8, further comprising at least one gas nozzle operable to deliver at least one gas substantially along the first path.

10. The apparatus of claim 1, wherein the apparatus is an automated gas tungsten arc welding device.

11. The apparatus of claim 1, wherein the torch body and the electrode are moveable relative to the heat transfer block.

12. A method of welding a work piece, comprising:
providing a torch body supporting an electrode at least partially extending from the torch body, the electrode having a longitudinal central axis therethrough;
providing a heat transfer block spaced apart from the electrode and at least partially intersecting the longitudinal central axis;
positioning the torch body and the heat transfer block in a plane spaced at least partially above a work piece;
supplying current to the electrode to form an electric arc between the electrode and the heat transfer block; and
delivering a filler proximate to the electric arc, wherein the filler is substantially liquified and deposited on the work piece positioned at least partially below the electric arc.

13. The method of claim 12, further comprising delivering a gas along a first path from above the electric arc, wherein the first path is directed toward the work piece and at least partially intersecting the electric arc.

14. The method of claim 13, further comprising delivering a gas along a second path aligned substantially along the longitudinal central axis.

15. The method of claim 14, further comprising delivering gas along a third path at least partially intersecting the electric arc.

16. The method of claim 12, further comprising delivering a coolant substantially through or adjacent the heat transfer block.

17. A method for welding a work piece using an arc weld device, comprising:
generating an electric arc between an electrode of an arc weld device and a heat transfer block spaced apart from the electrode; and
delivering a filler proximate to the electric arc, wherein the filler is substantially liquiefied and deposited on a work piece positioned at least partially below the electric arc.

18. The method of claim 17, further comprising delivering a gas along a first path from above the electric arc, wherein the first path is directed toward the work piece and at least partially intersecting the electric arc.

19. The method of claim 17, further comprising cooling the heat transfer block.
